(19) United States
(12) Patent Application Publication
(10) Pub. No.: US 2009/0269594 A1
(43) Pub. Date: Oct. 29, 2009

(54) FIBROUS STRUCTURES COMPRISING A SURFACE TREATING COMPOSITION AND METHODS FOR MAKING SAME

(76) Inventors: Kenneth Douglas Vinson, Toone, TN (US); Khosrow Parviz Mohammadi, Liberty Township, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/428,514

(22) Filed: Apr. 23, 2009

Related U.S. Application Data
(60) Provisional application No. 61/048,260, filed on Apr. 28, 2008.

(51) Int. Cl. B32B 27/12; B05D 1/02

(52) U.S. Cl. 428/447; 427/427.6

(57) ABSTRACT

Surface treating compositions employing polysiloxanes and emulsifying agents, fibrous structures treated with such surface treating compositions and methods for making same are provided.

### CROSS REFERENCE TO RELATED APPLICATION(S)

This application claims the benefit of U.S. Provisional Application No. 61/048,260, filed Apr. 28, 2008.

### FIELD OF THE INVENTION

The present invention relates to fibrous structures comprising a surface treating composition, more particularly, to fibrous structures comprising a surface treating composition comprising a polysiloxane and an emulsifying agent, methods for making same and the neat surface treating composition.

### BACKGROUND OF THE INVENTION

Fibrous structures having surfaces treated with polysiloxanes are known in the art. In one example, Puffs® facial tissues comprise a surface comprising a polysiloxane and emulsifying agents, for example nonionic surfactants. However, the weight ratio of the polysiloxane to the emulsifying agents is less than 5:1—it is about 2:1 for ease of emulsification and improved stability. In fact, surface treating compositions used to treat surfaces of fibrous structures, such as facial tissues, have comprised polysiloxanes and emulsifying agents at weight ratios of polysiloxane to emulsifying agents of about 2:1. Surface treating compositions comprising polysilioxanes and emulsifying agents at ratios of about 2:1, after being applied to a surface of a fibrous structure, results in the polysiloxanes migrating into the interior of the fibrous structure rather than substantially being retained on the surface of the fibrous structure.

The problem faced by formulators is how to make a surface treating composition that comprises polysiloxane and emulsifying agent such that after being applied to a surface of a fibrous structure, a sufficient amount of polysiloxane is retained on the surface of the fibrous structure such that the surface of the fibrous structure comprises polysiloxane and emulsifying agent at a weight ratio of greater than about 5:1.

There is a need for a surface treating composition comprising polysiloxane and emulsifying agents that when applied to a surface of a fibrous structure, such as a facial tissue, enhances the retention of the polysiloxane on the surface of the fibrous structure.

### SUMMARY OF THE INVENTION

The present invention solves the problem and need discussed above by providing a surface treating composition, a fibrous structure comprising a surface treated with a surface treating composition and a method for treating a surface of a fibrous structure with a surface treating composition.

In one example of the present invention, a fibrous structure comprising a surface comprising a polysiloxane and an emulsifying agent, wherein the polysiloxane and emulsifying agent are present on the surface of the fibrous structure at a weight ratio of polysiloxane to emulsifying agent of greater than about 5:1 and/or greater than about 10:1 and/or greater than about 15:1 and/or greater than about 20:1, is provided.

In another example of the present invention, a process for treating a surface of a fibrous structure in need of treatment, the process comprising the step of applying a surface treating composition according to the present invention to the surface of the fibrous structure such that the resulting treated surface of the fibrous structure comprises a polysiloxane and an emulsifying agent in a weight ratio of polysiloxane to emulsifying agent of greater than about 5:1 and/or greater than about 10:1 and/or greater than about 15:1 and/or greater than about 20:1, is provided.

In still another example of the present invention, a process for making a surface treating composition according to the present invention, the process comprising the steps of:

a. mixing a polysiloxane and an emulsifying agent to form a mixture, wherein the weight ratio of polysiloxane to emulsifying agent in the mixture is greater than about 5:1; and

b. adding water to the mixture to form the surface treating composition, wherein the weight ratio of polysiloxane to water in the surface treating composition is from about 3:1 to about 1:10.

In even another example of the present invention, a single- or multi-ply sanitary tissue product comprising a fibrous structure comprising a surface treating with a surface treating composition according to the present invention is provided.

Accordingly, the present invention provides a surface treating composition, a fibrous structure comprising a surface treated with a surface treating composition and a process for treating a surface of a fibrous structure in need of treatment with a surface treating composition.

### DETAILED DESCRIPTION OF THE INVENTION

“Fiber” as used herein means an elongate particulate having an apparent length greatly exceeding its apparent width, i.e. a length to diameter ratio of at least about 10. Fibers have some integrity, i.e. manifested by some intrinsic strength. If an apparent elongate particulate, supported by a substrate, fails to have enough instrinsic strength to support itself, it is not a fiber, but may be a faux fiber. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be desired since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, and bagasse can be used in this invention. Synthetic fibers and/or non-naturally occurring fibers, such as polymeric fibers including natural polymeric fibers such as starch and/or modified starch polymeric fibers, can also be used. Elastomeric polymers, polypropylene, polyethylene, polyester, polyolefin, and nylon, can be used. The polymeric fibers can be produced by spunbond processes, meltblown processes, and other suitable methods known in the art.

An embryonic fibrous web can be typically prepared from an aqueous dispersion of papermaking fibers, though dispersions in liquids other than water can be used. The fibers are dispersed in the carrier liquid to have a consistency of from about 0.1 to about 0.3 percent. It is believed that the present invention can also be applicable to moist forming operations where the fibers are dispersed in a carrier liquid to have a consistency of less than about 50% and/or less than about 10%. Further, it is believed that the present invention can also be applicable to dry forming operations wherein the fibers are dispersed in air.

“Fibrous structure” as used herein means a structure that comprises one or more fibers. In one example, a fibrous structure according to the present invention means an orderly arrangement of fibers within a structure in order to perform a function. Nonlimiting examples of fibrous structures of the present invention include composite materials (including reinforced plastics and reinforced cement), paper, fabrics (including woven, knitted, and non-woven), and absorbent pads (for example for diapers or feminine hygiene products). A bag of loose fibers is not a fibrous structure in accordance with the present invention.

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

“Sanitary tissue product” as used herein means a soft, low density (i.e. <about 0.15 g/cm3) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

In one example, the sanitary tissue product of the present invention comprises a fibrous structure according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue product rolls of the present invention may comprise a plurality of connected, but perforated sheets, that are separably dispensable from adjacent sheets.

The sanitary tissue products of the present invention may comprises additives such as softening agents, temporary wet strength agents, permanent wet strength agents, bulk softening agents, lotions, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

As used herein, the articles “a” and “an” when used herein, for example, “an emulsifying agent” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Surface Treating Composition

The surface treating composition comprises a polysiloxane and an emulsifying agent. The surface treating composition may comprise water. In one example, the surface treating composition comprises a polysiloxane, an emulsifying agent and water and is in the form of an emulsion.

In one example, the surface treating composition comprises greater than about 15% by weight of the composition of a polysiloxane. In another example, the surface treating composition comprises from about 5% to about 80% and/or from about 10% to about 60% and/or from about 15% to about 50% by weight of the composition of a polysiloxane.

In another example, the surface treating composition comprises greater than about 0.4% by weight of the composition of an emulsifying agent. In another example, the surface treating composition comprises from about 0.1% to about 5% and/or from about 0.2% to about 2.5% and/or from about 0.5% to about 1.5% by weight of the composition of an emulsifying agent.

In yet another example, the surface treating composition comprises greater than about 50% by weight of the composition of water. In another example, the surface treating composition comprises from about 15% to about 95% and/or from about 40% to about 90% and/or from about 50% to about 85% by weight of the composition of water.

The surface treating composition may contain polysiloxane, emulsifying agent and optionally water, at weight ratios of polysiloxane to emulsifying agent of greater than about 5:1 and/or greater than about 10:1 and/or greater than about 15:1 and/or greater than about 20:1 and polysiloxane to water of less than about 4:1 and/or from about 3:1 to about 1:10 and/or from about 2:1 to about 1:5.

The surface treating composition may exhibit a shear viscosity (Brookfield™ spindle #21 at 100 rpm) of greater than about 3 cP. In one example, the surface treating composition exhibits a shear viscosity of less than about 200 cP. In yet another example, the surface treating composition exhibits a shear viscosity of from about 10 to about 200 cP and/or from about 15 to about 175 cP and/or from about 20 to about 150 cP.

a. Polysiloxane

Nonlimiting examples of suitable polysiloxanes for use in the present invention include polydimethyl siloxanes as well as organofunctional silicones and mixtures thereof.

In one example, the polysiloxane comprises an amino-functional polysiloxane. In another example, the polysiloxane comprises an amino-functional polysiloxane comprising from about 0.05 to about 1.0 meq/g amino substitution. In still another example, the polysiloxane comprises an amino-functional polysiloxane comprising one or more amino ethyl amino propyl units.

The polysiloxane may be terminated with reactive functional groups and/or they may be capped to render them less reactive. Non-limiting examples of reactive end groups include a silanol termination, a methoxy silane termination, hydroxyl, methoxy and an amino termination. One example of end capping exhibiting generally less reactivity is the trimethyl silyl termination.

Nonlimiting examples of commercially available polysiloxanes include FX-6121 from Dow Corning Inc., LE128 from Wacker Inc., Silwet L-7222 and Y-12035 both from Momentive Performance Chemicals Inc.

b. Emulsifying Agent

Nonlimiting examples of emulsifying agents include surfactants. Nonlimiting examples of suitable surfactants include nonionic surfactants, anionic surfactant and mixtures thereof.

In one example, the emulsifying agent is a nonionic surfactant. In another example, the emulsifying agent is a nonionic surfactant comprising a C₁₀-C₁₄ hydrocarbyl polyoxyethylene ether having from about 3 to about 5 polyoxyethylene units. In still another example, the emulsifying agent is a nonionic surfactant comprising a C₁₂ hydrocarbyl polyoxyethylene ether having about 4 polyoxyethylene units.

In one example, the nonionic surfactant is derived from a linear primary alcohol. In another example, the nonionic surfactant comprises an alcohol ethoxylate.

The emulsifying agent may comprise a material that exhibits an HLB value of from about 4 to about 14 and/or from about 8 to about 12 and/or from about 9 to about 10.5.

Non-limiting examples of commercially available emulsifying agents include the Brij® series of polyoxyethyene ethers marketed by Croda Inc. and the Neodol® series of linear primary alchohol ethoxylates marketed by Shell, Inc.

c. Water

The surface treating composition of the present invention may comprise water.

In one example, the surface treating composition comprises a polysiloxane, water and the minimum amount of emulsifying agent to form an emulsion. The emulsion only needs to be stable long enough for the emulsion to be applied to a surface of a fibrous structure.

In one example, the surface treating composition consists essentially of a polysiloxane, an emulsifying agent and water. Other ingredients that do not inhibit and/or interfere with the functions of the polysiloxane, emulsifying agent and water and/or the intended function of the surface treating composition according to the present invention may be present in the surface treating composition.

Upon application of the surface treating composition onto a surface of a fibrous structure, the levels of the components of the surface treating composition may change. For example, the water, if any, present in the surface treating composition may evaporate or be driven off by a drying process. However, the weight ratio of the polysiloxane to the emulsifying agent will remain constant between the surface treating composition prior to application onto a surface of a fibrous structure and the surface treating composition after application to a surface of a fibrous structure.

d. Process for Making a Surface Treating Composition

The surface treating composition of the present invention may be made by any suitable process known in the art so long as the surface treating composition comprises a polysiloxane and an emulsifying agent in a weight ratio of polysiloxane to emulsifying agent of greater than about 5:1.

For example, the surface treating composition may be made by a process comprising the step of mixing a polysiloxane and an emulsifying agent to form a mixture, wherein the weight ratio of polysiloxane to emulsifying agent in the mixture is greater than about 5:1. The process may further comprise the step of adding water to the mixture to form the surface treating composition, wherein the weight ratio of polysiloxane to water in the surface treating composition is from about 3:1 to about 1:10. The step of adding water to the mixture may by accompanied by shearing of the mixture. In one example, the addition of the water may form a water-in-oil emulsion. The addition of water under shear may be continued until the emulsion inverts to an oil-in-water emulsion.

e. Nonlimiting Synthesis Example for a Surface Treating Composition

A mixture is prepared using 500 g of amino functional silicone, FX6121 from Dow Corning Inc. and 30 g of Brij 30 from Croda, Inc. Water, totaling 470 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a viscosity of about 1500 cP. In order to reduce the viscosity, a 100 g mixture of water and 6% Brij 30 is separately prepared by mixing together 94 g of water and 6 g of Brij 30. The Brij/water mixture is then added to the polysiloxane emulsion and worked in using high shear mixing with the IKA mill. The viscosity is reduced to about 560 cP. Two additional 100 g mixtures of 94 g of water and 6 g of Brij 30 are prepared and sequentially added to the polysiloxane emulsion with high shear mixing. The viscosity is now about 340 cP. To restore the polysiloxane concentration an increment of 300 g of FX-6121 is added while continuing the high shear mixing. In order to further reduce the viscosity, an additional quantity of 100 g mixture of water and 6% Brij 30 is separately prepared by and then added to the polysiloxane emulsion and worked in using high shear mixing with the IKA mill followed by addition of 100 g of FX-6121, while continuing the high shear mixing. The resultant viscosity is about 300 cP.

The emulsion has a polysiloxane content of 50%, a content of Brij 30 (an emulsifying agent) of 3%, and the balance 47% is water.

### Fibrous Structure

The surface treating composition may be applied to one or more surfaces of a fibrous structure by any suitable means such as spraying, printing, extruding, surface transfer, applying it view a rigid permeable material, such as a permeable roll over which a surface of the fibrous structure passes such that the surface treating composition exits the permeable roll and comes into contact with the surface of the fibrous structure.

The fibrous structure may be any suitable fibrous structure. For example, the fibrous structure may comprise a plurality of hydryoxyl polymer fibers, either naturally occurring, such as cellulosic wood pulp fibers, and/or non-naturally occurring, such as spun lyocell fibers and/or spun starch fibers. In one example, the hydroxyl polymer fibers comprise a material selected from the group consisting of: cellulose, cellulose derivatives, starch, starch derivatives, chitosan, chitosan derivatives, polyvinyl alcohol, polyvinyl alcohol derivatives, gums, proteins and mixtures thereof.

The fibrous structure comprising a surface treated with the surface treating composition may be utilized to form, at least in part, a single- or multi-ply sanitary tissue product.

In one example, a process for treating a surface of a fibrous structure in need of treatment, comprises the step of applying a surface treating composition according to the present invention to a surface of a fibrous structure in need of treatment such that the resulting treated surface of the fibrous structure comprises the polysiloxane and the emulsifying agent at a weight ratio of polysiloxane to emulsifying agent of greater than about 5:1.

### NONLIMITING EXAMPLES OF A FIBROUS STRUCTURE OF THE PRESENT INVENTION

### EXAMPLE 1

The surface treating composition synthesized above (i.e. the 50% polysiloxane emulsion) is diluted to 19% polysiloxane emulsion by adding water with thorough mixing. The surface treating composition is then ready to be applied to a surface of a fibrous structure.

The fibrous structure is prepared as follows. First, a slurry of eucalyptus fibers is prepared at about 3% by weight using a conventional repulper. The 3% eucalyptus fiber slurry is directed toward the headbox of a fourdrinier machine. Separately, an aqueous slurry of NSK fibers of about 3% by weight is made up using a conventional repulper.

In order to impart temporary wet strength to the finished fibrous structure, a 1% dispersion of temporary wet strengthening additive (e.g., Parez® 750) is prepared and is added to the NSK fiber stock pipe at a rate sufficient to deliver 0.3% temporary wet strengthening additive based on the dry weight of the NSK fibers. The absorption of the temporary wet strengthening additive is enhanced by passing the treated slurry through an in-line mixer.

The eucalyptus fiber slurry is diluted with white water at the inlet of a fan pump to a consistency of about 0.15% based on the total weight of the eucalyptus fiber slurry. The NSK fibers, likewise, are diluted with white water at the inlet of a fan pump to a consistency of about 0.15% based on the total weight of the NSK fiber slurry. The eucalyptus fiber slurry and the NSK fiber slurry are both directed to a layered headbox capable of maintaining the slurries as separate streams until they are deposited onto a forming fabric on the Fourdrinier.

The fibrous structure making machine has a layered headbox having a top chamber, a center chamber, and a bottom chamber. The eucalyptus combined fiber slurry is pumped through the top and bottom headbox chambers and, simultaneously, the NSK fiber slurry is pumped through the center headbox chamber and delivered in superposed relation onto the Fourdrinier wire to form thereon a three-layer embryonic web, of which about 70% is made up of the eucalyptus fibers and 30% is made up of the NSK fibers. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern densified tissue with discontinuous low-density deflected areas arranged within a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 12 mils above the supporting fabric. A suitable process for making the patterned drying fabric is described in published application US 2004/0084167 A1.

Further de-watering is accomplished by vacuum assisted drainage until the web has a fiber consistency of about 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 800 fpm. The fibrous structure is wound in a roll using a surface driven reel drum having a surface speed of about 656 feet per minute.

The fibrous structure is subsequently converted into a two-ply web having a basis weight of about 50 g/m²by combining two plies orientated so that the smooth (i.e. Yankee-side) surfaces are outwardly facing.

The 19% polysiloxane emulsion is applied to the surface of the two ply fibrous structure using a slot extrusion apparatus so that 0.5% by weight polysiloxane is wiped onto the surface of the fibrous structure.

The resultant two ply fibrous structure is converted into a soft and strong sanitary bath tissue paper product.

### EXAMPLE 2

This example illustrates the advantages of this invention by preparing two sanitary tissue paper products each having an equivalent amount of polysiloxane surface treatment. The first uses a range of polysiloxane/emulsifier ratio within the present invention; the second uses a polysiloxane/emulsifier ratio outside the present invention.

Emulsion A is prepared using 500 g of amino functional polysiloxane, LE128 from Wacker Chemie and 30 g of Brij 30 from Croda, Inc. Water, totaling 470 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a polysiloxane content of 50% and a viscosity of about 34 cP. The 50% polysiloxane emulsion is further diluted to 33% concentration by adding water with thorough mixing.

Emulsion B is prepared using 500 g of amino functional polysiloxane, LE128 from Wacker Chemie and 250 g of the Brij 30 emulsifier. Water, totaling 250 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a polysiloxane content of 50% after which it is further diluted to 33% concentration by adding water with thorough mixing.

Each of the 33% polysiloxane emulsions (A & B) are applied to the surface of a two ply fibrous structure made according to the procedure of Example 1 using a slot extrusion apparatus so that 0.5% by weight polysiloxane is wiped onto the surface of the fibrous structure.

Each of the resultant two ply fibrous structure is converted into a sanitary bath tissue paper product. The sanitary tissue product employing emulsion A is softer than the sanitary tissue product employing Emulsion B.

### EXAMPLE 3

A polysiloxane emulsion is prepared using 250 g of Momentive Y-12035 from Momentive Performance Materials and 250 g of Silwet L-7220 from Momentive Performance Materials and 30 g of Brij 30 from Croda, Inc. Water, totaling 470 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a polysiloxane content of 50% and a viscosity of about 34 cP. The 50% polysiloxane emulsion is further diluted to 33% concentration by adding water with thorough mixing.

Emulsion B is prepared using 500 g of amino functional polysiloxane, LE128 from Wacker Chemie and 250 g of the Brij 30 emulsifier from Croda, Inc. Water, totaling 250 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a polysiloxane content of 50% after which it is further diluted to 33% concentration by adding water with thorough mixing.

Each of the 33% polysiloxane emulsions (A & B) are applied to the surface of a two ply fibrous structure made according to the procedure of Example 1 using a slot extrusion apparatus so that 0.5% by weight polysiloxane is wiped onto the surface of the fibrous structure.

Each of the resultant two ply fibrous structure is converted into a sanitary bath tissue paper product. The sanitary tissue product employing emulsion A is softer than the sanitary tissue product employing Emulsion B. The fibrous structure comprising emulsion A exhibited a softness win of 60-40 in a spot feel test versus the fibrous structure comprising emulsion B. Further, softness was tested using a softness panel with 0.3 PSU gain by the fibrous structure with emulsion A versus the fibrous structure with emulsion B as measured by the Softness Test Method described herein.

### EXAMPLE 4

A polysiloxane emulsion is prepared using 500 g of Momentive Y-12035 from Momentive Performance Materials and 30 g of Brij 30 from Croda, Inc. Water, totaling 470 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a polysiloxane content of 50% and a viscosity of about 34 cP. The 50% polysiloxane emulsion is further diluted to 33% concentration by adding water with thorough mixing.

Emulsion B is prepared using 500 g of amino functional polysiloxane, LE128 from Wacker Chemie and 250 g of the Brij 30 emulsifier from Croda, Inc. Water, totaling 250 g is added to this mixture by adding in 5-10 g increments, while high shear mixing. Each increment of water is worked-in before adding the next increment. The process of working-in the water includes the use of an IKA laboratory homogenizer on highest shear setting. After the total water addition, the resultant emulsion has a polysiloxane content of 50% after which it is further diluted to 33% concentration by adding water with thorough mixing.

Each of the 33% polysiloxane emulsions (A & B) are applied to the surface of a two ply fibrous structure made according to the procedure of Example 1 using a slot extrusion apparatus so that 0.5% by weight polysiloxane is wiped onto the surface of the fibrous structure.

Each of the resultant two ply fibrous structure is converted into a sanitary bath tissue paper product. The sanitary tissue product employing emulsion A is softer than the sanitary tissue product employing Emulsion B.

Softness of the treated fibrous structures was tested using a softness panel with 0.3 PSU gain by the fibrous structure with emulsion A versus the fibrous structure with emulsion B as measured by the Softness Test Method described herein.

### Test Methods

### Softness Test Method

Ideally, prior to softness testing, the samples to be tested should be conditioned according to TAPPI Method #T4020M-88. Here, samples are preconditioned for 24 hours at a relative humidity level of 10 to 35% and within a temperature range of 22° C. to 40° C. After this preconditioning step, samples should be conditioned for 24 hours at a relative humidity of 48% to 52% and within a temperature range of 22° C. to 24° C. Ideally, the softness panel testing should take place within the confines of a constant temperature and humidity room. If this is not feasible, all samples, including the controls, should experience identical environmental exposure conditions.

Softness testing is performed as a paired comparison in a form similar to that described in “Manual on Sensory Testing Methods”, ASTM Special Technical Publication 434, published by the American Society For Testing and Materials 1968 and is incorporated herein by reference. Softness is evaluated by subjective testing using what is referred to as a Paired Difference Test. The method employs a standard external to the test material itself. For tactile perceived softness two samples are presented such that the subject cannot see the samples, and the subject is required to choose one of them on the basis of tactile softness. The result of the test is reported in what is referred to as Panel Score Unit (PSU). With respect to softness testing to obtain the softness data reported herein in PSU, a number of softness panel tests are performed. In each test ten practiced softness judges are asked to rate the relative softness of three sets of paired samples. The pairs of samples are judged one pair at a time by each judge: one sample of each pair being designated X and the other Y. Briefly, each X sample is graded against its paired Y sample as follows:

1. a grade of plus one is given if X is judged to may be a little softer than Y, and a grade of minus one is given if Y is judged to may be a little softer than X;

2. a grade of plus two is given if X is judged to surely be a little softer than Y, and a grade of minus two is given if Y is judged to surely be a little softer than X;

3. a grade of plus three is given to X if it is judged to be a lot softer than Y, and a grade of minus three is given if Y is judged to be a lot softer than X; and, lastly:

4. a grade of plus four is given to X if it is judged to be a whole lot softer than Y, and a grade of minus 4 is given if Y is judged to be a whole lot softer than X.

The grades are averaged and the resultant value is in units of PSU. The resulting data are considered the results of one panel test. If more than one sample pair is evaluated then all sample pairs are rank ordered according to their grades by paired statistical analysis. Then, the rank is shifted up or down in value as required to give a zero PSU value to which ever sample is chosen to be the zero-base standard. The other samples then have plus or minus values as determined by their relative grades with respect to the zero base standard. The number of panel tests performed and averaged is such that about 0.2 PSU represents a significant difference in subjectively perceived softness.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising a surface comprising a polysiloxane and an emulsifying agent wherein the polysiloxane and emulsifying agent are present on the surface at a weight ratio of polysiloxane to emulsifying agent of greater than about 5:1.

2. The fibrous structure according to claim 1 wherein the weight ratio of polysiloxane to emulsifying agent is greater than about 10:1.

3. The fibrous structure according to claim 2 wherein the weight ratio of polysiloxane to emulsifying agent is greater than about 15:1.

4. The fibrous structure according to claim 3 wherein the weight ratio of polysiloxane to emulsifying agent is greater than about 20:1.

5. The fibrous structure according to claim 1 wherein the polysiloxane comprises an amino-functional polysiloxane.

6. The fibrous structure according to claim 5 wherein the amino-functional polysiloxane comprises from about 0.05 to about 1.0 meq/g amino substitution.

7. The fibrous structure according to claim 5 wherein the amino-functional polysiloxane comprises one or more amino ethyl amino propyl units.

8. The fibrous structure according to claim 1 wherein the polysiloxane comprises a trimethyl silyl termination.

9. The fibrous structure according to claim 1 wherein the polysiloxane comprises at least one reactive end group comprising a moiety selected from the group consisting of: hydroxyl, methoxy and mixtures thereof.

10. The fibrous structure according to claim 1 wherein the emulsifying agent comprises a nonionic surfactant.

11. The fibrous structure according to claim 10 wherein the nonionic surfactant comprises a C₁₀-C₁₄ hydrocarbyl polyoxyethylene ether having from about 3 to about 5 polyoxyethylene units.

12. The fibrous structure according to claim 11 wherein the nonionic surfactant comprises a C₁₂ hydrocarbyl polyoxyethylene ether having about 4 polyoxyethylene units.

13. The fibrous structure according to claim 1 wherein the fibrous structure comprises a plurality of hydryoxyl polymer fibers.

14. The fibrous structure according to claim 13 wherein the hydroxyl polymer fibers comprise a material selected from the group consisting of: cellulose, cellulose derivatives, starch, starch derivatives, chitosan, chitosan derivatives, polyvinyl alcohol, polyvinyl alcohol derivatives, gums, proteins and mixtures thereof.

15. A single- or multi-ply sanitary tissue product comprising a fibrous structure according to claim 1.

16. A process for treating a surface of a fibrous structure in need of treatment, the process comprising the step of applying a surface treating composition comprising a polysiloxane, an emulsifying agent, and water to a surface of a fibrous structure in need of treatment such that the resulting treated surface of the fibrous structure comprises the polysiloxane and the emulsifying agent at a weight ratio of polysiloxane to emulsifying agent of greater than about 5:1.

17. The process according to claim 16 wherein the surface treating composition exhibits a viscosity of from about 10 to about 200 cP.

18. The process according to claim 16 wherein the step of applying a surface treating composition comprises spraying the surface treating composition onto the surface of a fibrous structure in need of treatment.

19. A process for making a surface treating composition, the process comprising the steps of:
a. mixing a polysiloxane and emulsifying agent to form a mixture, wherein the weight ratio of polysiloxane to emulsifying agent in the mixture is greater than about 5:1; and
b. adding water to the mixture to form the surface treating composition, wherein the weight ratio of polysiloxane to water in the surface treating composition is from about 3:1 to about 1:10.

20. The process according to claim 19 wherein the step of adding water to the mixture comprises shearing the mixture.
